(19) United States
(12) Patent Application Publication
(10) Pub. No.: US 2026/0201954 A1
(43) Pub. Date: Jul. 16, 2026

(54) SEALING RING ASSEMBLY FOR SEALING A ROTATING SHAFT ON EXTRACTION EQUIPMENT

(71) Applicant: Crown Iron Works Company LLC, Blaine, MN (US)

(72) Inventors: Jeff Kraker, Blaine, MN (US); Jeff Garritsen, Forest Lake, MN (US); Benjamin Wayne Floan, Andover, MN (US)

(21) Appl. No.: 19/020,775

(22) Filed: Jan. 14, 2025

(51) Int. Cl. F16J 15/3268

(52) U.S. Cl. CPC F16J 15/3268

(57) ABSTRACT

A sealing ring system is described that includes a housing having a bore and a sealing ring receiving cavity extending radially from the bore, a rotatable shaft protrudes at least partially through the bore. A first plurality of sealing rings is positioned over the rotatable shaft and in the sealing ring receiving cavity, and a second plurality of sealing rings adjacent to the first plurality of sealing rings and positioned over the rotatable shaft and in the sealing ring receiving cavity. The first plurality of sealing rings having a first ring having a first slit, a second sealing ring having a second slit, and the first slit may be rotationally offset from the second slit. The second plurality of sealing rings may include a third ring having a third slit, a fourth sealing ring having a fourth slit, and the third slit may be rotationally offset from the fourth slit.

### TECHNICAL FIELD

This disclosure relates to seal assemblies and, more particularly, to seal assemblies for sealing rotating shafts used on extraction equipment.

### BACKGROUND

A variety of different industries use extractors to extract and recover substances entrained within solids. For example, producers of products from renewable organic sources use extractors to extract carbohydrates and/or oil from solid matter, such as soybeans, rapeseed, sunflower seed, peanuts, cottonseed, palm kernels, and corn germ. The matter is contacted with a solvent within the extractor, causing the desired product to be extracted from a surrounding cellular structure into the solvent. As another example, extractors are used to recover asphalt from shingles and other petroleum-based waste materials. Typically, the petroleum-based material is ground into small particles and then passed through an extractor to extract the asphalt from the solid material into a surrounding organic solvent.

After the matter is processed through the extractor, the residual solvent-wet solid material is desolventized. Desolventizing vaporizes solvent from the solid material, allowing the solvent to be recovered for reuse in the extraction process as well as drying the solid material for downstream use or disposal. A desolventizing apparatus may include various rotating components that control the movement of solids and/or vapor through the apparatus. For example, the desolventizing apparatus may have a moving or rotating arm that sweeps solvent wet solid material across a tray toward a discharge opening on the tray, allowing the material to move from one tray to another tray down the desolventizing apparatus. As another example, the desolventizing apparatus may include one or more valves that open and close to control movement of material through the vessel. Each valve can be connected to a shaft extending outside of the desolventizing apparatus that is rotatable to controllably open and close the valve. Independent of the application, a rotating shaft may need to be sealed to prevent ingress and/or egress of material and/or gas from an interior of the vessel to an exterior environment.

### SUMMARY

In general, this disclosure is directed to seal assemblies for rotating shafts and associated systems and techniques. In some examples, the described seal assemblies are installed about a rotating shaft extending into a sealed vessel that is part of an extraction system. In some examples, the sealed vessel may be a desolventizer apparatus. A desolventizer apparatus may be used downstream of a solid-liquid or liquid-liquid extraction device to reduce the solvent content of solvent wet solids produced by the extraction device. The desolventizer apparatus may have multiple trays that the solvent wet solids material contacts in series as it flows through the desolventizer apparatus. Each tray may define a desolventizer stage and create a processing space between adjacent trays. The processing space may be substantially pressure isolated from adjacent spaces, for example, by including a pressure regulating device, such as, for example, a rotary valve, between adjacent trays. Each rotary valve may be connected to a shaft extending outside of the desolventizer apparatus that is rotatable to controllably open and close each valve. In some cases, the rotating shaft may need to be sealed to prevent ingress and/or egress of material into or out of the desolventizer apparatus. While a rotating shaft associated with a desolventizer apparatus is one example shaft that can be sealed using the systems and techniques of the disclosure, the sealing systems of the disclosure can be used to seal rotating shafts in other applications.

In some examples, a sealing ring system includes multiple sets of sealing rings positionable over a shaft being sealed. The sealing ring system can include at least one ring (e.g., a first set of multiple rings) that are sized to contact the outer surface of the rotating shaft without contacting an inner wall surface of a housing through which the shaft extends. These one or more rings can rotate as the shaft rotates. The sealing ring system can include at least one additional ring (e.g., a second set of multiple rings) that are sized to contact inner wall surface of a housing through which the shaft extends without contacting the shaft. These one or more rings can act as stators.

Each ring of the sealing ring system can have a slit that allows the ring to be deformed for installation over the shaft and/or compressed when inserted into the housing. The slits of the different rings can be rotationally offset from each other, e.g., to inhibit matter passing through a slit of one ring from further passing through a slit of an adjacent ring. For example, within each set of rings, different rings may have slits extending at non-perpendicular angles across the ring. The slits may be oriented in opposite directions. If the rings were to rotate relative to each in such a configuration, the slits of adjacent rings will not overlap along their entire length but, instead, may only cross an intersection point (e.g., intersecting lines of a “X”). This can provide further protection to prevent ingress or egress of material if the slits of the rings inadvertently align and overlap.

While the rings of the sealing ring system can be fabricated from a variety of different materials, in some examples, each sealing ring is fabricated from metal. For example, each sealing ring may be cut from a sheet of metal (e.g., die cut, laser cut). Such fabrication can provide an efficient and economical sealing ring system. Example metals that may be used to fabricate each sealing ring include standard carbon steel, stainless steel, and/or a high strength steel, such as spring steel. Spring steel typically is a low-alloy manganese, medium-carbon steel or high-carbon steel with a very high yield strength. This can allow objects made of spring steel to return to their original shape despite significant deflection or twisting.

In one example, a sealing ring system is described that includes a housing having a bore and a sealing ring receiving cavity extending radially from the bore, the sealing ring receiving cavity defining an inner surface. A rotatable shaft may protrude at least partially through the bore, the rotatable shaft defining an outer surface. A first plurality of sealing rings may be positioned over the rotatable shaft and in the sealing ring receiving cavity. Each of the first plurality of sealing rings may include (a) an inner perimeter contacting the outer surface of the rotatable shaft and (b) an outer perimeter offset from the inner surface of the sealing ring receiving cavity. A second plurality of sealing rings may be adjacent to the first plurality of sealing rings and may be positioned over the rotatable shaft and in the sealing ring receiving cavity. Each of the second plurality of sealing rings may have (a) an outer perimeter contacting the inner surface of the sealing ring receiving cavity and (b) an inner perimeter offset from the outer surface of the rotatable shaft. The first plurality of sealing rings may include a first ring having a first slit, a second sealing ring having a second slit, and the first slit may be rotationally offset from the second slit. The second plurality of sealing rings may include a third ring having a third slit, a fourth sealing ring having a fourth slit, and the third slit may be rotationally offset from the fourth slit.

In another example, a sealing ring system is described that includes a first plurality of sealing rings positioned over the rotatable shaft and in the sealing ring receiving cavity, each of the first plurality of sealing rings may include (a) an inner perimeter contacting the outer surface of the rotatable shaft and (b) an outer perimeter offset from the inner surface of the sealing ring receiving cavity. A second plurality of sealing rings may be adjacent to the first plurality of sealing rings and may be positioned over the rotatable shaft and in the sealing ring receiving cavity, each of the second plurality of sealing rings may include (a) an outer perimeter contacting the inner surface of the sealing ring receiving cavity and (b) an inner perimeter offset from the outer surface of the rotatable shaft. The first plurality of sealing rings may include a first ring having a first slit, a second sealing ring having a second slit, and the first slit may be rotationally offset from the second slit. The second plurality of sealing rings may include a third ring having a third slit, a fourth sealing ring having a fourth slit, and the third slit may be rotationally offset from the fourth slit.

In another example, a method of sealing a rotating shaft may include splitting a first sealing ring along a first slit and inserting the first sealing ring over a rotatable shaft and in a sealing ring receiving cavity of a shaft housing such that an inner perimeter of the first sealing ring contacts an outer surface of the rotatable shaft and an outer perimeter of the first sealing ring is offset from an inner surface of the sealing ring receiving cavity. Splitting a second sealing ring along a second slit and inserting the second sealing ring over the rotatable shaft and in the sealing ring receiving cavity of the shaft housing such that an inner perimeter of the second sealing ring contacts the outer surface of the rotatable shaft and an outer perimeter of the second sealing ring is offset from the inner surface of the sealing ring receiving cavity. The method may further include positioning the first slit of the first sealing ring rotationally offset from the second slit of the second sealing ring, splitting a third sealing ring along a third slit and positioning the third sealing ring adjacent to the second sealing ring and over the rotatable shaft and in the sealing ring receiving cavity such that an outer perimeter of the third sealing ring contacts the inner surface of the sealing ring receiving cavity and an inner perimeter of the third sealing ring is offset from the outer surface of the rotatable shaft, splitting a fourth sealing ring along a fourth slit and positioning the fourth sealing ring adjacent to the third sealing ring and over the rotatable shaft and in the sealing ring receiving cavity such that an outer perimeter of the fourth sealing ring contacts the inner surface of the sealing ring receiving cavity and an inner perimeter of the fourth sealing ring is offset from the outer surface of the rotatable shaft, and positioning the third slit of the third sealing ring rotationally offset from the fourth slit of the fourth sealing ring.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a perspective cutaway view of an example desolventizer-toaster (DT) system.

FIG. 2 is a cross-sectional view of an example sealing ring system of the example desolventizer-toaster of FIG. 1.

FIG. 3 is a perspective view illustrating a first plurality of sealing rings and a second plurality of sealing rings.

FIG. 4 is a front perspective view of a fifth sealing ring and a sixth sealing ring.

FIG. 5A is a front perspective view of a first plurality of sealings rings, where the first plurality of sealing rings are in alignment, illustrating a point of intersection for a first slit and a second slit.

FIG. 5B is an enlarged view of Circle 5B, as in FIG. 5A.

FIG. 6 is a flow diagram illustrating a method of sealing a rotating shaft.

### DETAILED DESCRIPTION

This disclosure generally relates to seal assemblies for rotating shafts and associated systems and techniques. In some examples, the described seal assemblies are installed about a rotating shaft extending into a sealed vessel that is part of an extraction system. In some examples, the sealed vessel may be a desolventizer apparatus. A desolventizer apparatus may be used downstream of a solid-liquid or liquid-liquid extraction device to reduce the solvent content of solvent wet solids produced by the extraction device. The desolventizer apparatus may have multiple trays that the solvent wet solids material contacts in series as it flows through the desolventizer apparatus. Each tray may define a desolventizer stage and create a processing space between adjacent trays. The processing space may be substantially pressure isolated from adjacent spaces, for example, by including a pressure regulating device, such as, for example, a rotary valve, between adjacent trays. Each rotary valve may be connected to a shaft extending outside of the desolventizer apparatus that is rotatable to controllably open and close each valve. In some cases, the rotating shaft may need to be sealed to prevent ingress and/or egress of material into or out of the desolventizer apparatus.

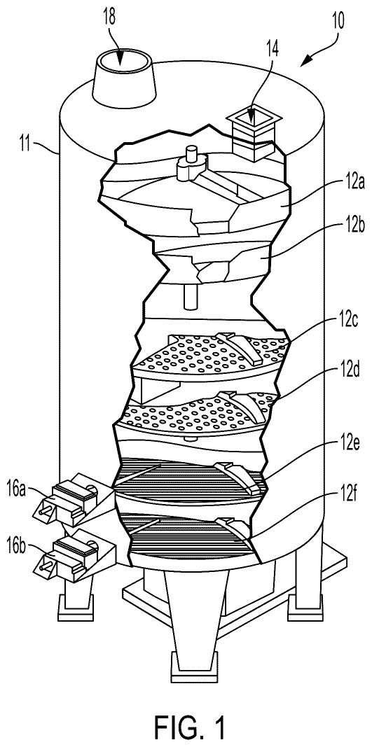

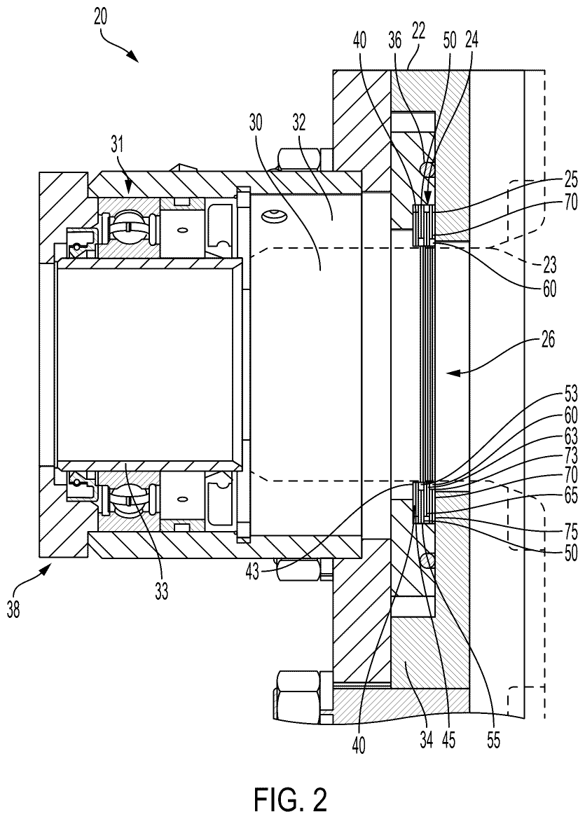

Details on example sealing ring systems according to the disclosure will be described with respect to FIGS. 2-6. However, an example desolventizer-toaster system will first be described with respect to FIG. 1 to contextualize an apparatus on which a sealing ring system according to the disclosure may be used.

FIG. 1 is a perspective cutaway view of an example desolventizer-toaster (DT) system 10. The desolventizer-toaster (DT) system 10 is operable to remove solvent from solvent-containing solid material introduced into the system. The desolventizer-toaster (DT) system 10 may or may not further “toast” or brown the outside surface of the solid material being processed, e.g., resulting in denaturing of protein present in the material being processed. Accordingly, it should be appreciated that the characterization of system 10 as a desolventizer-toaster is representative of example ranges of solvent removal and drying that may be achieved in different implementations of the concepts described herein but is not intended to be limiting or require a specific degree of solvent removal or drying to be achieved. Accordingly, the desolventizer-toaster (DT) system 10 is also referred to as “desolventizer 10.”

In the example shown in FIG. 1, the desolventizer 10 is illustrated as including a vessel housing 11 that contains a plurality of trays 12A-12F (referred to herein as trays 12). The trays 12 are arranged vertically relative to each other in a stacked arrangement with respect to gravity. That is, a first tray 12A is positioned vertically above a second tray 12B which, in turn, is positioned vertically above a third tray 12C, which, in turn, is positioned vertically above a fourth tray 12D, which, in turn, is positioned vertically above a fifth tray 12E, and finally, a sixth tray 12F. While it is illustrated that the example desolventizer 10 may include six rays, the desolventizer 10 may include fewer trays (e.g., two, three, four, five trays), or more trays (e.g., seven, eight, nine, or more), and the disclosure is not limited in this respect.

Desolventizer vessel housing 11 may include an inlet opening 14 and an outlet opening (not explicitly shown in FIG. 1). In operation, material to be processed (e.g., desolventized, dried) enters the housing 11 of the desolventizer 10 via the inlet opening 14 and flows vertically downward through the desolventizer 10 before exiting through the outlet. As the material to be processed flows through the desolventizer 10, the material may flow over each of the respective trays 12 in the desolventizer 10. The material may or may not physically contact the top surface of each of the trays 12, depending on whether the material flows on top of underlying material as it passes over a particular tray 12. Each tray 12 can have one or more outlet openings that allow material to flow through the tray 12 and down to an underlying tray 12 or outlet (e.g., after a desired residence time on a particular tray).

In general, any type of wetted solid material may be processed using the desolventizer 10. Example types of solid material that can be processed using the desolventizer 10 may include, but are not limited to, oleaginous matter, such as soybeans (and/or soy protein concentrate), rapeseed, sunflower seed, peanuts, cottonseed, palm kernels, and corn germ; oil-bearing seeds and fruits; asphalt containing materials (e.g., asphalt-containing roofing shingles that include an aggregate material such as crushed mineral rock, asphalt, and a fiber reinforcing); stimulants (e.g., nicotine, caffeine); alfalfa; almond hulls; anchovy meals; bark; coffee beans and/or grounds; carrots; chicken parts; chlorophyll; diatomic pellets; fish meal; hops; oats; pine needles; tar sands; vanilla; and wood chips and/or pulp. Such materials may be wetted with an aqueous, organic, and/or inorganic liquid. Typical types of liquids that may be wetting the solid material being processed on the desolventizer 10 may include, but are not limited to, a hydrocarbon (e.g., acetone, hexane, toluene), alcohol (e.g., isopropyl alcohol, ethanol, other alcohols), and water.

In practice, the desolventizer 10 may be utilized as part of an extraction system that receives wetted solid from an upstream extraction device. The extractor may be an immersion extractor, a percolation extractor, or yet another type of extraction device. Within the extraction device, material to be processed is contacted with a solvent, e.g., in continuous or batch mode. For example, the extraction device may be a countercurrent extractor in which solid material to be processed is introduced at one end and conveyed to an opposite end of the extractor while an extraction solvent is introduced into the extractor at an opposite end and flows towards the end where the solid material enters. As the solvent travels through the extractor from the inlet to the outlet, the solvent can flow in a countercurrent direction to the flow of solid material passing through the extractor. The solvent intermixes with the solid material within extractor, causing the extract carried by the solid material to transfer from the solid material to the solvent. Accordingly, in operation, solvents having a comparatively low concentration of extract enters at an inlet while solvent having an increased concentration of extract discharges at an outlet. Likewise, fresh solid material carrying extract enters at an inlet of the extractor while residual solid material having a reduced concentration of extract is discharged at an outlet of the extractor. It is this solid material that is wetted with solvent from the extractor that may be conveyed to the desolventizer 10 for drying.

Independent of the source of the material being processed on the desolventizer 10, the desolventizer 10 may heat and dry (by vaporizing solvent) the solvent wet material introduced into the device. A variety of different sources of direct and/or indirect heating may be used to supply thermal energy to the solid material being processed. For example, one or more (e.g., all) of trays 12 may provide indirect heating to the solid material being processed. Each such tray may have openings across its thickness that allows a thermal transfer fluid (e.g., steam) to pass through the tray and heat the tray without causing the thermal transfer fluid to enter the space the solid material being processed flows through. Additionally or alternatively, one or more of trays 12 may provide direct heating, e.g., by having a steam sparge that injects steam up through the tray into the material being processed. The sidewalls of the vessel housing 11 may or may not be heated.

For example, different trays of the desolventizer 10 may be heated differently depending on their position within the desolventizer 10. The uppermost tray or trays (e.g., top two or three trays depending on vessel size) may be predesolventizing tray(s). These tray(s) may use indirect heat to flash vaporize solvent from the solvent wet solid material as the solvent wet solid material contacts the hot tray surface. The main or middle trays (e.g., middle-most one, two, three, four, or five trays depending on vessel size) may provide both indirect heating and direct steam contact to remove the bulk of the solvent from the solvent wet solid. This can also add moisture to the solvent wet solid, e.g., where is desired to steam cook the material, such as when processing residual solid from an oilseed feedstock. The lowermost tray or trays (e.g., bottom two or three trays depending on vessel size) may be a sparge tray. The sparging tray may be perforated for direct barge steam injection, which can strip the final residual solvent from the solid material being processed and vent upwardly through the desolventizer 10.

Independent of the configuration, desolventizer 10 may include rotating shafts to control movement of valves, sweep arms, etc. Each shaft may extend through an opening in a wall of the vessel defining the desolventizer, with a portion of the shaft positioned inside of the vessel and a portion of the shaft positioned outside of the vessel. Various sealing and bearing features may be provided at or adjacent the wall of the vessel around the shaft.

FIG. 2 is a cross-sectional view of an example sealing ring system 20 according to the disclosure that can be used on desolventizer-toaster 10 of FIG. 1. As previously discussed, the sealing ring system 20 may be utilized within a rotary valve (e.g., rotary valves 16A, 16B). While it is discussed herein that the sealing ring system 20 may be used within a rotary valve of a desolventizer-toaster 10, it is contemplated that the sealing ring system 20 may be used within various types of machinery, equipment, and/or pipelines to prevent the leakage of gas or liquid. For example, the sealing ring system 20 may be used within automotive engines, hydraulic systems, pumps, turbines, or any other rotating machinery as desired.

As shown in FIG. 2, the sealing ring system 20 may include a housing 22 including a bore 26. The housing 22 may be a processing vessel, such as the desolventizer-toaster 10, that receives solid and/or liquid material for processing and may define a pressured environment relative to an external ambient environment. In the illustrated configuration, the housing 22 may include a pair of spaced apart vessel wall surfaces 34 separated by a rotatable shaft 30. Each vessel wall surface 34 forms the bore 26 (e.g., an opening) into which a bearing assembly 38 is inserted. In operation, the rotatable shaft 30 can rotate relative to the bearing assembly 38 while the assembly remains in a fixed position relative to the housing 22. The rotatable shaft 30 may extend across the housing 22, and may protrude, at least partially, through the bore 26 of the housing 22. The rotatable shaft 30 may include a cylindrical shape with a circular cross-sectional shape, although other shapes can be used without departing from the scope of the disclosure.

The bore 26 of the housing 22 may have a substantially constant cross-sectional area across its length or may have a cross-sectional area that is different at one or more locations from a cross-sectional area at one or more other locations. In the illustrated configuration, for example, the bore 26 may include a cylindrical cross-section having a constant internal diameter as it extends through the vessel wall surface 34. The sealing ring system 20 may include an annular sleeve 33 and an annular bearing 31. The annular sleeve 33 may be an annular, or ring-shaped, structure having an inner opening into which the annular bearing 31 and a rotatable shaft 30 may be inserted. The annular bearing 31 may be an annular, or ring-shaped, structure configured to fit inside of the annular sleeve 33. The annular sleeve 33 may function as a protective surface to minimize possible wear on the draft from direct contact. For example, the annular sleeve 33 may be formed from a stronger, more robust material than the annular bearing 31, helping to protect the annular bearing 31 from degradation during transport, assembly, and operation of the sealing ring system 20. The annular bearing 31 may include an internal size and shape (e.g., internal diameter) that corresponds to an outer size and shape (e.g., outer diameter) of the rotatable shaft 30. The annular bearing 31 may provide a comparatively low-friction surface about which the rotatable shaft 30 can rotate. The annular bearing 31 may be one of a plurality of bearings extending circumferentially about an outer surface 23 of the rotatable shaft 30, between the outer surface 23 of the rotatable shaft 30 and the bore 26. The plurality of bearings may be positioned outwardly along the rotatable shaft 30 from the first plurality of sealing rings 40 and the second plurality of sealing rings 50.

The sealing ring system 20 may further include a sealing ring receiving cavity 24. The sealing ring receiving cavity 24 may extend radially from the bore 26 and may be formed between the vessel wall surface 34 and a laminar sealing ring housing 36. In some cases, the sealing ring receiving cavity 24 may be formed, at least in part, by the laminar sealing ring housing 36. The sealing ring receiving cavity 24 may house a first plurality of sealing rings 40, a second plurality of sealing rings 50, a third plurality of sealing rings 60, and a fourth plurality of sealing rings 70.

While it is illustrated that the sealing ring system 20 may include the first plurality of sealing rings 40 and the second plurality of sealing rings 50, the third plurality of sealing rings 60, and the fourth plurality of sealing rings 70, it is contemplated that sealing ring systems according to the disclosure may utilizing further or more sets (pluralities) of sealing rings without departing from the disclosure. For example, sealing ring system 20 may utilize only one or two pluralities of sealing rings (e.g., one set contacting the sealing ring housing that does not move with the rotating shaft and one set contacting the rotating shaft that moves with the rotating shaft) or more pluralities of sealing rings (e.g., five, six, seven, eight, or more pluralities of sealing rings.

In some implementations, sealing ring system 20 includes an odd number of pluralities of sealing rings (e.g., three, five, seven) with the outer sets of sealing rings being static or stationary sets of rings contacting the sealing ring housing that do not move with the rotating shaft with one or more sets of sealing rings contacting and rotating with the shaft positioned between the stationary sets of rings. For example, sealing ring system 20 may have an arrangement of three sets of sealing rings (stationary-moving-stationary) or an arrangement of five sets of sealing rings (stationary-moving-stationary-moving-stationary).

With further reference to the example illustrated configuration, each of the plurality of sealing rings 40, 50, 60, 70 may be configured to be positioned over the rotatable shaft 30 and within the sealing ring receiving cavity 24. The plurality of sealing rings 40, 50, 60, 70, may be positioned in an alternating arrangement thereby optimizing the seal and creating a labyrinth-type mechanical seal. In the example shown, the first plurality of sealing rings 40 each include an inner perimeter 43 contacting the outer surface 23 of the rotatable shaft 30 and an outer perimeter 45 offset from an inner surface 25 of the sealing ring receiving cavity 24. The outer perimeter 45 may be offset from the inner surface 25 of the sealing ring receiving cavity 24 a distance within a range of about 1 mm to about 4 mm. The second plurality of sealing rings 50, which may be positioned adjacent to the first plurality of sealing rings 40, each include an outer perimeter 55 contacting the inner surface 25 of the sealing ring receiving cavity 24, and an inner perimeter 53 offset from the outer surface 23 of the rotatable shaft 30. The inner perimeter 53 may be offset from the outer surface 23 a distance within a range of about 1 mm to about 4 mm.

Further, the third plurality of sealing rings 60, which may be positioned adjacent to the second plurality of sealing rings 50, each include an inner perimeter 63 contacting the outer surface 23 of the rotatable shaft 30 and an outer perimeter 65 offset from an inner surface 25 of the sealing ring receiving cavity 24. The outer perimeter 65 may be offset from the inner surface 25 of the sealing ring receiving cavity 24 a distance within a range of about 1 mm to about 4 mm. The fourth plurality of sealing rings 70, which may be positioned adjacent to the third plurality of sealing rings 60, each include an outer perimeter 75 contacting the inner surface 25 of the sealing ring receiving cavity 24, and an inner perimeter 73 offset from the outer surface 23 of the rotatable shaft 30. The inner perimeter 73 may be offset from the outer surface 23 a distance within a range of about 1 mm to about 4 mm. This pattern of alternating the positioning of each of the pluralities of sealing rings may continue for as many pluralities of sealing rings are desired.

While it is illustrated that the pluralities of sealing rings 40, 50, 60, 70 include an alternating arrangement, other arrangements may be contemplated. For example, the pluralities of sealing rings may include a columnar arrangement in which each of the pluralities of sealing rings includes a differing size. For example, a first plurality of sealing rings may include a first size and a second plurality of sealing rings, positioned adjacent to the first plurality of sealing rings, may include a second size. A third plurality of sealing rings positioned adjacent to the second plurality of sealing rings may include a size similar to or the same as the size of the first plurality of sealing rings, and the fourth plurality of sealing rings, positioned adjacent to the third plurality of sealing rings, may include a size similar to or the same as the size of the second plurality of sealing rings. In another example, each adjacent plurality of sealing rings includes a differing size from one another. In yet another example, each of the pluralities of sealing rings may include a size matching that of each adjacent plurality of sealing rings. These are just examples.

In some examples, one of the first plurality of sealing rings 40 may be positioned in contact with one of the second plurality of sealing rings 50, and one of the third plurality of sealing rings 60 may be positioned in contact with one of the fourth plurality of sealing rings 70. In some cases, the first plurality of sealing rings 40 may be rotatable relative to the second plurality of sealing rings 50, and the third plurality of sealing rings 60 may be rotatable relative to the fourth plurality of sealing rings 70. In some cases, a lubricating material, such as oil, graphite, grease, or other lubricant, may be used within an adjacent cavity 32 to improve the function of the pluralities of sealing rings as well as a sealing performance and/or may be positioned between adjacent sets of sealing rings.

For example, in one configuration, sealing ring system 20 may include two sets of sealing rings. A lubricant (e.g., grease) can be positioned between the two sets of sealing rings. Such a configuration may be used in lieu of using a single set of sealing rings and a lip seal with grease in between, which may be used in other applications.

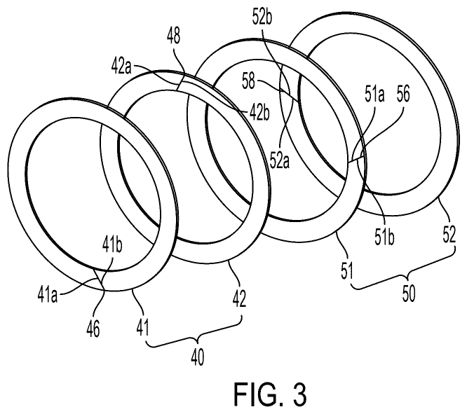

FIG. 3 is a perspective view illustrating the first plurality of sealing rings 40 and the second plurality of sealing rings 50, as in FIG. 2. As can be seen in FIG. 3, the first plurality of sealing rings 40 may include a first ring 41 and a second ring 42, and the second plurality of sealing rings 50 may include a third ring 51 and a fourth ring 52. While it is illustrated that the first plurality of sealing rings 40 and the second plurality of sealing rings 50 each include two rings, fewer sealing rings or more sealing rings may be implemented for each feature described as being a plurality of sealing rings. In different examples, each plurality of sealing rings can include only two sealing rings or at least two sealing rings (e.g., two, three, four, five, six, or more sealing rings). Each plurality of sealing rings can have the same number of sealing rings, or different ones of the plurality of sealing rings can have different numbers of sealing rings from each other.

In some examples, each plurality of sealing rings includes at least three sealing rings, with each of the sealing rings having a slit that is rotationally offset from each other. Including at least three sealing rings in each plurality of sealing rings can be useful to provide multiple rotationally offset slit intersections in each sealing ring group, helping to reduce the likelihood of ring seam overlap and corresponding bypass through the ring system. For example, when sealing ring system 20 includes three sets of sealing rings (e.g., stationary-moving-stationary) each set of sealing rings may include at least three sealing rings (e.g., 3 or more stationary rings—3 or more moving rings—3 or more stationary rings).

With further reference to FIG. 3, the first plurality of sealing rings 40 may include the first ring 41 and the second ring 42. The first ring 41 may include a first slit 46 at a first non-perpendicular angle across a width of the first ring 41. The first slit 46 may divide the first ring 41 into a first free end 41A and a second free end 41B. The first slit 46 may include a thickness of less than 1 mm (millimeter), such as within a range from about 0.65 mm to about 0.25 mm. The second ring 42 may include a second slit 48 at a second non-perpendicular angle across a width of the second ring 42. The second slit 48 may divide the second ring 42 into a first free end 42A and a second free end 42B. The second slit 48 may include a thickness of less than 1 mm (millimeter), such as within a range from about 0.65 mm to about 0.25 mm.

The second plurality of sealing rings 50 may include the third ring 51 and the fourth ring 52. The third ring 51 may include a third slit 56 at a third non-perpendicular angle across a width of the third ring 51. The third slit 56 may divide the third ring 51 into a first free end 51A and a second free end 51B. The third slit 56 may include a thickness of less than 1 mm (millimeter), such as within a range from about 0.65 mm to about 0.25 mm. The fourth ring 52 may include a fourth slit 58 at a fourth non-perpendicular angle across a width of the fourth ring 52. The fourth slit 58 may divide the fourth ring 52 into a first free end 52A and a second free end 52B. The fourth slit 58 may include a thickness of less than 1 mm (millimeter), such as within a range from about 0.65 mm to about 0.25 mm.

In some cases, the first non-perpendicular angle of the first slit 46 may be different than the second non-perpendicular angle of the second slit 48, and the third non-perpendicular angle of the third slit 56 may be different than the fourth non-perpendicular angle of the fourth slit 58. For example, the first non-perpendicular angle may extend in an opposite direction from the second non-perpendicular angle, and the third non-perpendicular angle may extend in an opposite direction from that of the fourth non-perpendicular angle. In some cases, any of the first, second, third, or fourth non-perpendicular angles may be within a range of 15 degrees to 80 degrees, preferably 35 degrees.

The first slit 46, the second slit 48, the third slit 56, and the fourth slit 58 may allow for a diameter expansion and compression of the first ring 41, the second ring 42, the third ring 51, and the fourth ring 52, respectively, about the rotatable shaft 30. In some cases, the first slit 46, the second slit 48, the third slit 56, and the fourth slit 58 may allow for the first ring 41, the second ring 42, the third ring 51, and the fourth ring 52, respectively, to be expanded such that the first ring 41, the second ring 42, the third ring 51, and the fourth ring 52, can be flexed around and onto the rotatable shaft 30.

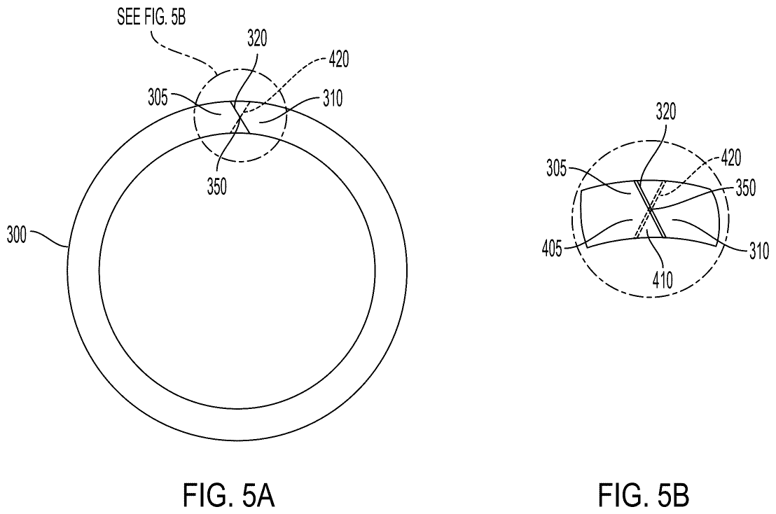

In operation, the first ring 41 and the second ring 42 may be positioned such that the first slit 46 and the second slit 48 are rotationally offset from one another, and the third ring 51 and the fourth ring 52 may be positioned such that the third slit 56 and the fourth slit 58 are rotationally offset from one another. In some cases, the first slit 46 is rotationally offset from the second slit 48 within a range from 120 degrees to 240 degrees, preferably 180 degrees. In some cases, the third slit 56 is rotationally offset from the fourth slit 58 within a range from 120 degrees to 240 degrees, preferably 180 degrees. When the first ring 41 and the second ring 42, and the third ring 51 and the fourth ring 52 are rotationally offset from one another, the possible opening between the sealing rings is greatly reduced, thereby minimizing the leakage of fluid into and/or out of the housing 22. In use, when the rotatable shaft 30 rotates, such movement may cause movement of the pluralities of sealing rings 40, 50, 60, 70. Said movement may cause the first slit 46, the second slit 48, the third slit 56, and the fourth slit 58 to move out of position and potentially align with one another. However, when the first ring 41 and the second ring 42, and the third ring 51 and the fourth ring 52 each have a respective slit having a non-perpendicular angle different than the adjacent slit, a point of intersection between adjacent slits is greatly reduced, as shown in FIGS. 5A to 5B.

In some cases, the first plurality of sealing rings 40 and the second plurality of sealing rings 50 may be formed from a laser cut sheet metal, such as stainless steel, aluminum, brass, copper, mild steel, or any other suitable type of metal. In some cases, the first plurality of sealing rings 40 and the second plurality of sealing rings 50 may be formed from a rubber, a polymeric compound, or the like. The first plurality of sealing rings 40 and the second plurality of sealing rings 50 may each include a width within a range of about 5 mm to about 25 mm, such as from 10 mm to 20 mm. These are just examples.

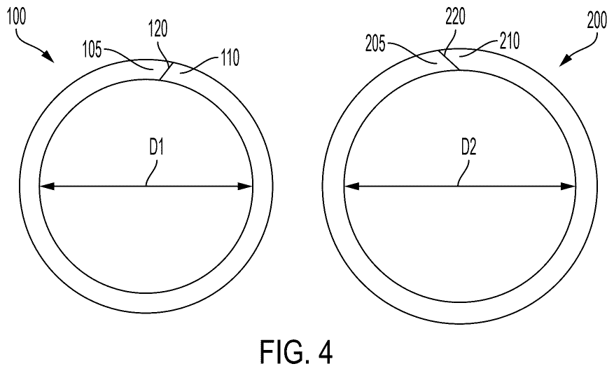

FIG. 4 is a front perspective view of a fifth sealing ring 100 and a sixth sealing ring 200. The fifth sealing ring 100 may include a fifth slit 120, a first free end 105 and a second free end 110. The fifth sealing ring 100 may be one of the first plurality of sealing rings 40. The fifth slit 120 may be positioned such that it is rotationally offset from the first slit 46 and the second slit 48. The sixth sealing ring 200 may include a sixth slit 220, a first free end 205 and a second free end 210. The sixth sealing ring 200 may be one of the second plurality of sealing rings 50. The sixth slit 220 may be positioned such that it is rotationally offset from the third slit 56 and the fourth slit 58.

As shown in FIG. 4, the fifth sealing ring 100 has an inner diameter D₁ that is less than an inner diameter D₂ of the sixth sealing ring 200. As previously discussed, with reference to FIG. 2, the pluralities of sealing rings may include a columnar arrangement in which each of the pluralities of sealing rings includes a differing size. For example, a first plurality of sealing rings may include a first size and a second plurality of sealing rings, positioned adjacent to the first plurality of sealing rings, may include a second size. By varying the sizes of the rings and positioning each of the slit rotationally offset from one another, sealing is optimized and leakage of fluid is greatly reduced.

FIG. 5A is a front perspective view of a first plurality of sealings rings, wherein the first plurality of sealing rings are in alignment, illustrating a point of intersection for a first slit and a second slit, and FIG. 5B is an enlarged view of Circle 5B, as in FIG. 5A.

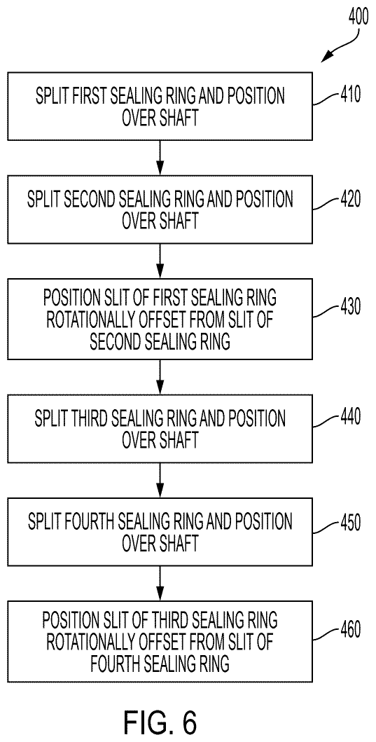

FIG. 6 is a flow diagram illustrating a method 400 of sealing a rotating shaft (e.g., rotatable shaft 30). The method 400 may include splitting a first sealing ring along a first slit and inserting the first sealing ring over a rotatable shaft and in a sealing ring receiving cavity of a shaft housing such that an inner perimeter of the first sealing ring contacts an outer surface of the rotatable shaft and an outer perimeter of the first sealing ring is offset from an inner surface of the sealing ring receiving cavity, as referenced by block 410. In some cases, the housing may be a desolventizer. Further, the method 400 may include splitting a second sealing ring along a second slit and inserting the second sealing ring over the rotatable shaft and in the sealing ring receiving cavity of the shaft housing such that an inner perimeter of the second sealing ring contacts the outer surface of the rotatable shaft and an outer perimeter of the second sealing ring is offset from the inner surface of the sealing ring receiving cavity, as referenced by block 420, and positioning the first slit of the first sealing ring rotationally offset from the second slit of the second sealing ring, as referenced by block 430.

The method 400 may further include splitting a third sealing ring along a third slit and positioning the third sealing ring adjacent to the second sealing ring and over the rotatable shaft and in the sealing ring receiving cavity such that an outer perimeter of the third sealing ring contacts the inner surface of the sealing ring receiving cavity and an inner perimeter of the third sealing ring is offset from the outer surface of the rotatable shaft, as referenced by block 440. The method 400 may include splitting a fourth sealing ring along a fourth slit and positioning the fourth sealing ring adjacent to the third sealing ring and over the rotatable shaft and in the sealing ring receiving cavity such that an outer perimeter of the fourth sealing ring contacts the inner surface of the sealing ring receiving cavity and an inner perimeter of the fourth sealing ring is offset from the outer surface of the rotatable shaft, as referenced by block 450, and positioning the third slit of the third sealing ring rotationally offset from the fourth slit of the fourth sealing ring, as referenced by block 460. In some cases, the method 400 may further include rotating the rotatable shaft (e.g., rotatable shaft 30) relative to the housing.

It should be appreciated that the descriptive terms “top” and “bottom” with respect to the configuration and orientation of components described herein are used for purposes of illustration based on the orientation in the figures. The arrangement of components in real world application may vary depending on their orientation with respect to gravity. Accordingly, unless otherwise specified, the general terms “first” and “second” may be used interchangeably with the terms “top” and “bottom” without departing from the scope of disclosure.

Various examples have been described. These and other examples are within the scope of the following claims.

1. A sealing ring system comprising:
a housing having a bore and a sealing ring receiving cavity extending radially from the bore, the sealing ring receiving cavity defining an inner surface;
a rotatable shaft protruding at least partially through the bore, the rotatable shaft defining an outer surface;
a first plurality of sealing rings positioned over the rotatable shaft and in the sealing ring receiving cavity, each of the first plurality of sealing rings having (a) an inner perimeter contacting the outer surface of the rotatable shaft and (b) an outer perimeter offset from the inner surface of the sealing ring receiving cavity; and
a second plurality of sealing rings adjacent to the first plurality of sealing rings and being positioned over the rotatable shaft and in the sealing ring receiving cavity, each of the second plurality of sealing rings having (a) an outer perimeter contacting the inner surface of the sealing ring receiving cavity and (b) an inner perimeter offset from the outer surface of the rotatable shaft,
wherein the first plurality of sealing rings comprises a first ring having a first slit, a second sealing ring having a second slit, and the first slit is rotationally offset from the second slit, and
the second plurality of sealing rings comprises a third ring having a third slit, a fourth sealing ring having a fourth slit, and the third slit is rotationally offset from the fourth slit.

2. The sealing ring system of claim 1, wherein:
the first slit extends at a first non-perpendicular angle across a width of the first sealing ring;
the second slit extends at a second non-perpendicular angle across a width of the second sealing ring;
the third slit extends at a third non-perpendicular angle across a width of the third sealing ring; and
the fourth slit extends at a second non-perpendicular angle across a width of the fourth sealing ring.

3. The sealing ring system of claim 2, wherein the first non-perpendicular angle is different than the second non-perpendicular angle, and the third non-perpendicular angle is different than the fourth non-perpendicular angle.

4. The sealing ring system of claim 2, wherein the first non-perpendicular angle extends in an opposite direction from the second non-perpendicular angle, and the third non-perpendicular angle extends in an opposite direction from the fourth non-perpendicular angle.

5. The sealing ring system of claim 1, wherein the first slit is rotationally offset from the second slit and the third slit is rotationally offset from the fourth slit, each being rotationally offset within a range from 120 degrees to 240 degrees.

6. The sealing ring system of claim 1, wherein:
the first slit divides the first sealing ring into a first free end and a second free end, the first slit having a thickness less than 1 mm;
the second slit divides the second sealing ring into a first free end and a second free end, the second slit having a thickness less than 1 mm;
the third slit divides the third sealing ring into a first free end and a second free end, the third slit having a thickness less than 1 mm; and
the fourth slit divides the fourth sealing ring into a first free end and a second free end, the fourth slit having a thickness less than 1 mm.

7. The sealing ring system of claim 1, wherein the first plurality of sealing rings and the second plurality of sealing rings each have a width within a range from 5 mm to 25 mm.

8. The sealing ring system of claim 1, wherein:
the outer perimeter of the first plurality of sealing rings is offset from the inner surface of the sealing ring receiving cavity a distance within a range from 1 mm to 4 mm; and
the inner perimeter of the second plurality of sealing rings is offset from the outer surface of the rotatable shaft a distance within a range from 1 mm to 4 mm.

9. The sealing ring system of claim 1, wherein:
the first plurality of sealing rings are rotatable relative to the second plurality of sealing rings; and
one of the first plurality of sealing rings is positioned in contact with one of the second plurality of sealing rings.

10. The sealing ring system of claim 1, further comprising a third plurality of sealing rings positioned over the rotatable shaft and in the sealing ring receiving cavity, each of the third plurality of sealing rings having (a) an outer perimeter contacting the inner surface of the sealing ring receiving cavity and (b) an inner perimeter offset from the outer surface of the rotatable shaft;
wherein the third plurality of sealing rings comprises a fifth ring having a fifth slit, a sixth sealing ring having a sixth slit, and the fifth slit is rotationally offset from the sixth slit; and
the first plurality of sealing rings is positioned between the second plurality of sealing rings and the third plurality of sealing rings.

11. The sealing ring system of claim 1, wherein the first plurality of sealing rings further comprises a fifth sealing ring having a fifth slit, wherein the fifth slit is rotationally offset from the first slit and the second slit.

12. The sealing ring system of claim 1, further comprising a plurality of bearings extending circumferentially about the outer surface of the rotatable shaft between the outer surface of the rotatable shaft and the bore, the plurality of bearings being positioned outwardly along the shaft from the first plurality of sealing rings and the second plurality of sealing rings.

13. The sealing ring system of claim 1, wherein:
the housing comprises a vessel wall surface;
the bore extends through the vessel wall surface; and
the vessel defines a pressured environment relative to an external ambient environment.

14. The sealing ring system of claim 13, wherein the vessel is a desolventizer.

15. A sealing ring system comprising:
a first plurality of sealing rings positioned over the rotatable shaft and in the sealing ring receiving cavity, each of the first plurality of sealing rings having (a) an inner perimeter contacting the outer surface of the rotatable shaft and (b) an outer perimeter offset from the inner surface of the sealing ring receiving cavity; and
a second plurality of sealing rings adjacent to the first plurality of sealing rings and being positioned over the rotatable shaft and in the sealing ring receiving cavity, each of the second plurality of sealing rings having (a) an outer perimeter contacting the inner surface of the sealing ring receiving cavity and (b) an inner perimeter offset from the outer surface of the rotatable shaft,
wherein the first plurality of sealing rings comprises a first ring having a first slit, a second sealing ring having a second slit, and the first slit is rotationally offset from the second slit, and
the second plurality of sealing rings comprises a third ring having a third slit, a fourth sealing ring having a fourth slit, and the third slit is rotationally offset from the fourth slit.

16. The sealing ring system of claim 15, wherein:
the first slit extends at a first non-perpendicular angle across a width of the first sealing ring;
the second slit extends at a second non-perpendicular angle across a width of the second sealing ring;
the third slit extends at a third non-perpendicular angle across a width of the third sealing ring; and
the fourth slit extends at a second non-perpendicular angle across a width of the fourth sealing ring.

17. The sealing ring system of claim 16, wherein the first non-perpendicular angle is different than the second non-perpendicular angle, and the third non-perpendicular angle is different than the fourth non-perpendicular angle.

18. The sealing ring system of claim 15, wherein the first slit is configured to be rotationally offset from the second slit and the third slit is configured to be rotationally offset from the fourth slit, each being rotationally offset within a range from 120 degrees to 240 degrees.

19. A method of sealing a rotating shaft, the method comprising:
splitting a first sealing ring along a first slit and inserting the first sealing ring over a rotatable shaft and in a sealing ring receiving cavity of a shaft housing such that an inner perimeter of the first sealing ring contacts an outer surface of the rotatable shaft and an outer perimeter of the first sealing ring is offset from an inner surface of the sealing ring receiving cavity;
splitting a second sealing ring along a second slit and inserting the second sealing ring over the rotatable shaft and in the sealing ring receiving cavity of the shaft housing such that an inner perimeter of the second sealing ring contacts the outer surface of the rotatable shaft and an outer perimeter of the second sealing ring is offset from the inner surface of the sealing ring receiving cavity;
positioning the first slit of the first sealing ring rotationally offset from the second slit of the second sealing ring;
splitting a third sealing ring along a third slit and positioning the third sealing ring adjacent to the second sealing ring and over the rotatable shaft and in the sealing ring receiving cavity such that an outer perimeter of the third sealing ring contacts the inner surface of the sealing ring receiving cavity and an inner perimeter of the third sealing ring is offset from the outer surface of the rotatable shaft;
splitting a fourth sealing ring along a fourth slit and positioning the fourth sealing ring adjacent to the third sealing ring and over the rotatable shaft and in the sealing ring receiving cavity such that an outer perimeter of the fourth sealing ring contacts the inner surface of the sealing ring receiving cavity and an inner perimeter of the fourth sealing ring is offset from the outer surface of the rotatable shaft; and
positioning the third slit of the third sealing ring rotationally offset from the fourth slit of the fourth sealing ring.

20. The method of claim 19, wherein the shaft housing is part of a desolventizer, and further comprising rotating the rotatable shaft relative to shaft housing.
